(19) United States
(12) Patent Application Publication
(10) Pub. No.: US 2020/0240274 A1
(43) Pub. Date: Jul. 30, 2020

(54) BLADE TIP POCKET RIB

(71) Applicant: PRATT & WHITNEY CANADA CORP., Longueuil (CA)

(72) Inventors: Vincent PARADIS, Longueuil (CA); Othmane LEGHZAOUNI, Brossard (CA); Masoud ROSHAN FEKR, Saint-Lambert (CA); Marc-Antoine MAILLOUX-LABROUSSE, Montreal (CA)

(21) Appl. No.: 16/256,166

(22) Filed: Jan. 24, 2019

(51) Int. Cl. F01D 5/18

(52) U.S. Cl. CPC F01D 5/187; F05D 2220/32; F05D 2260/20

(57) ABSTRACT

A turbine blade for a gas turbine engine, the turbine blade having a peripheral blade tip wall surrounding a radially recessed tip pocket, the peripheral blade tip wall having: a wall height; a leading edge; a trailing edge; a pressure side wall; and a suction side wall; and a rib extending between the pressure side wall and the suction side wall defining a leading portion and a trailing portion of the radially recessed tip pocket, the rib having a rib height less than the wall height.

### TECHNICAL FIELD

The disclosure relates generally to gas turbine engines, and more particularly to turbine blades having a tip pocket.

### BACKGROUND

Turbine blades used in gas turbine engines and other turbines have a radially outward blade tip that rotates at high speed relative to a peripheral shroud defining the engine gas path. Maintaining a minimal gap between the blade tip and shroud serves to improve engine efficiency.

Turbine blade tips of an internally cooled turbine blade are cooled with cooling air exhausted through openings in the tip. The turbine blade tips are exposed to high gas temperature and mechanical forces imposed by the high rotation speed. Thermo-mechanical fatigue life of the airfoil and blade tips in particular can determine the repair cycle of an engine which may involve removal and replacement of turbine blades. Improvement is desirable to reduce the costs and delays involved with engine downtime caused by thermo-mechanical fatigue of turbine blade tips.

### SUMMARY

In one aspect, the disclosure describes a turbine blade for a gas turbine engine, the turbine blade having a peripheral blade tip wall surrounding a radially recessed tip pocket, the peripheral blade tip wall having: a wall height; a leading edge; a trailing edge; a pressure side wall; and a suction side wall; and a rib extending between the pressure side wall and the suction side wall defining a leading portion and a trailing portion of the radially recessed tip pocket, the rib having a rib height less than the wall height. Embodiments can include combinations of the above features.

Further details of these and other aspects of the subject matter of this application will be apparent from the detailed description included below and the drawings.

### DESCRIPTION OF THE DRAWINGS

FIG. 1 shows an axial cross-section view of a turbo-fan gas turbine engine.

FIG. 2 is a radially inward view of a first example turbine blade tip with two tip pockets divided by a full height rib.

FIG. 3 is a radially inward view of a second example a turbine blade tip with a full tip pocket extending from a leading edge to a trailing edge.

FIG. 4 is a radially inward view of an example turbine blade tip in accordance with the present description with a tip pocket divided by a partial height rib into leading and trailing portions.

FIG. 5 is a detail view of the rib and a leading portion of the radially recessed tip pocket, where the rib has a rib height less than the wall height.

FIG. 6 is a radial sectional view through the rib and tip pocket along arcuate section line 6-6 of FIG. 4.

### DETAILED DESCRIPTION

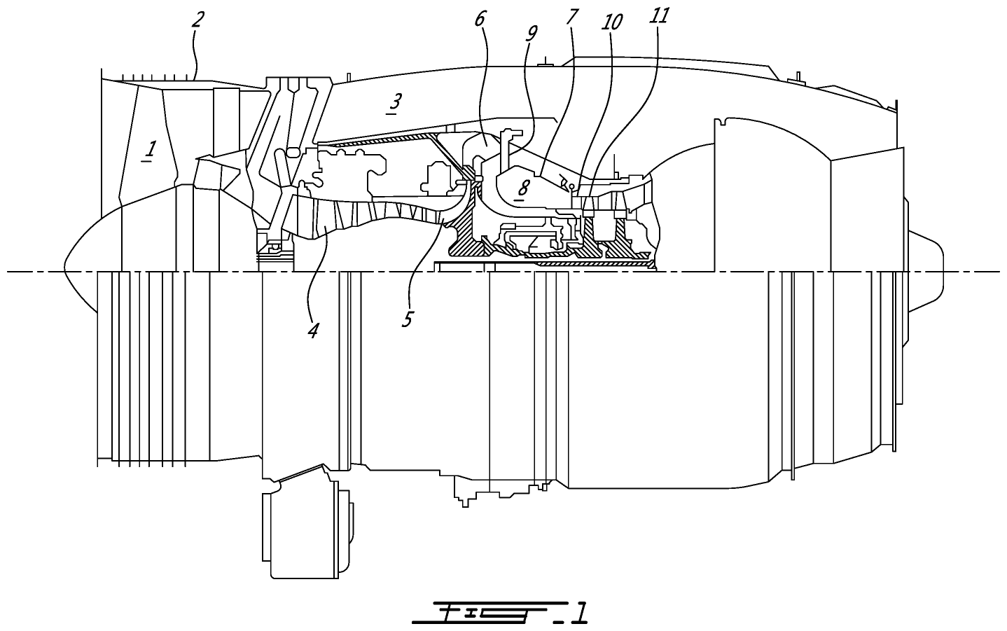

FIG. 1 shows an axial cross-section through an example of turbo-fan gas turbine engine. Air intake into the engine passes over fan blades 1 in a fan case 2 and is then split into an outer annular flow through the bypass duct 3 and an inner flow through the low-pressure axial compressor 4 and high-pressure centrifugal compressor 5. Compressed air exits the compressor 5 through a diffuser 6 and is contained within a plenum 7 that surrounds the combustor 8. Fuel is supplied to the combustor 8 through fuel tubes 9 and fuel is mixed with air from the plenum 7 when sprayed through nozzles into the combustor 8 as a fuel air mixture that is ignited. A portion of the compressed air within the plenum 7 is admitted into the combustor 8 through orifices in the side walls to create a cooling air curtain along the combustor walls or is used for cooling to eventually mix with the hot gases from the combustor and pass over the nozzle guide vane 10 and turbines 11 before exiting the tail of the engine as exhaust. A portion of the cooling air created in the compressor 5 is used for internal cooling of the turbines 11.

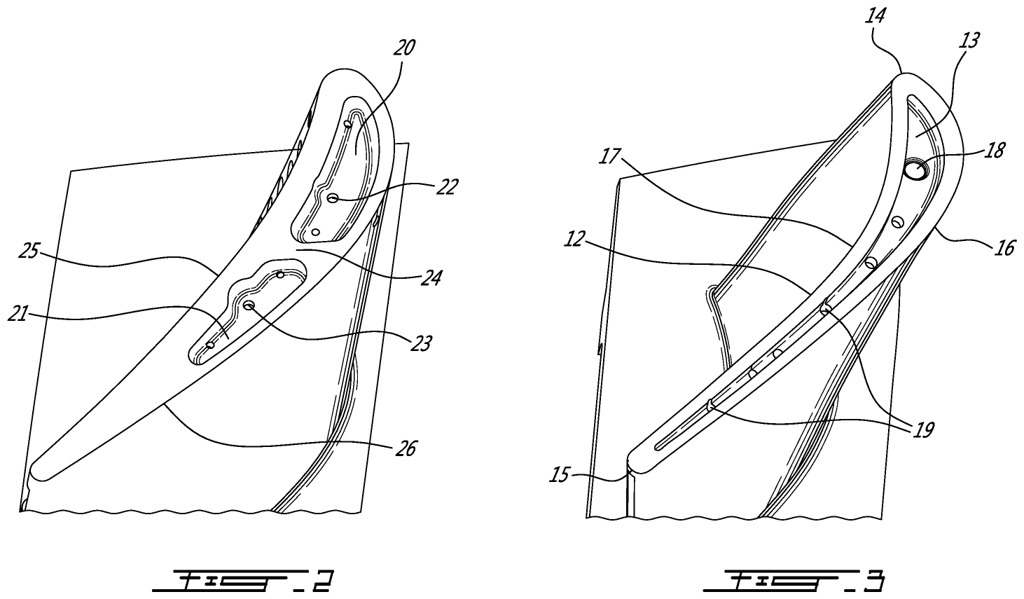

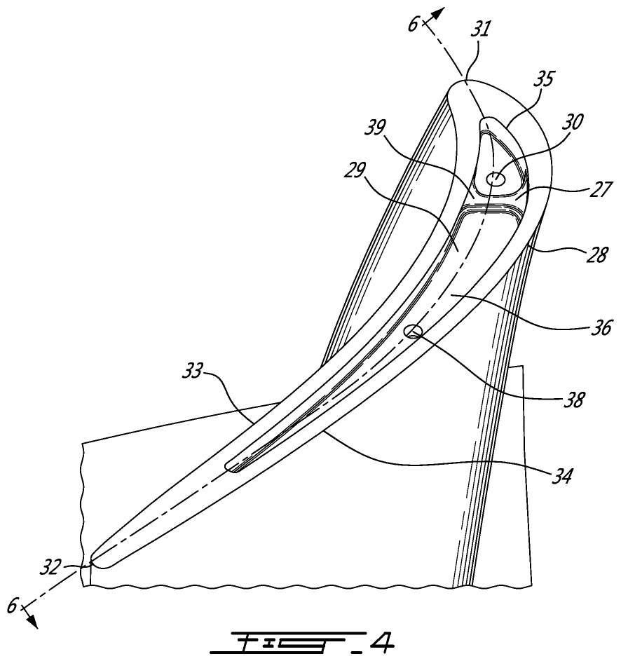

Turbines 11 have a central hub and a peripheral array of replaceable turbine blades. FIGS. 2 and 3 show the radially outward tips of such turbine blades. FIG. 3 shows a peripheral blade tip wall 12 surrounding a single full length radially recessed tip pocket 13. The peripheral blade tip wall 12 has a wall height, a leading edge 14, a trailing edge 15, a suction side wall 16, and a pressure side wall 17. The example of FIG. 3 has a relatively large leading opening 18 and a series of smaller openings 19 leading toward the trailing edge 15. The openings 18, 19 communicate with the internal cooling channels of the turbine blade that are supplied with pressurized cooling air to cool the blade tip and the peripheral blade tip wall 12 in particular which is exposed to hot gas and mechanical stress during high speed operation.

FIG. 2 shows another example with two separate tip pockets 20, 21 also supplied with cooling air via openings 22, 23. The tip pockets 20, 21 are separated by an intermediate wall 24 that joins the pressure side wall 25 and the suction side wall 26.

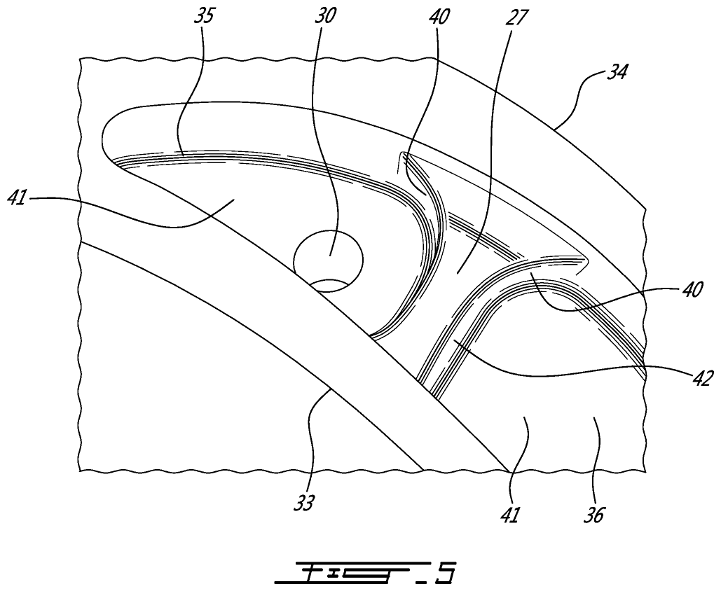

FIGS. 4-6 show a turbine blade tip having a partial height rib 27. A peripheral blade tip wall 28 surrounds a radially recessed tip pocket 29. As best seen in FIG. 6, the peripheral blade tip wall 28 has a wall height “h₁” and the rib 27 has a rib height “h₂” which is less than the wall height “h₁”. A single rib 27 or multiple ribs 27 can be located to reinforce the peripheral blade tip wall 28 without significantly impeding cooling air flow. Cooling air exhausted through a leading cooling air exhaust hole 30 can cascade downstream over the rib 27.

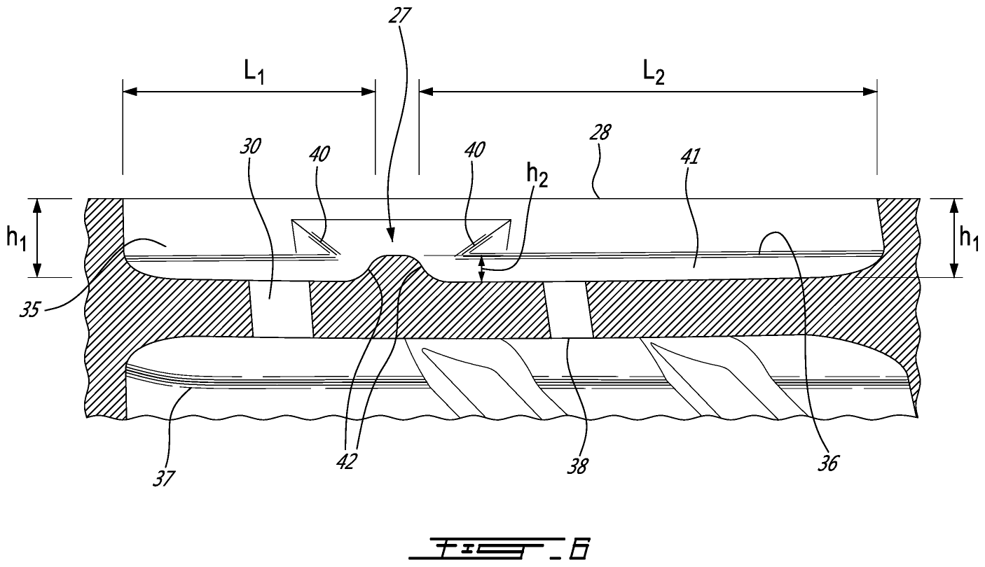

Referring to FIGS. 4 and 5, the peripheral blade tip wall 28 has a leading edge 31, a trailing edge 32, a pressure side wall 33 and a suction side wall 34. The rib 27 extends between the pressure side wall 33 and the suction side wall 34. The rib 27 defines a leading portion 35 and a trailing portion 36 of the radially recessed tip pocket 29. The leading portion 35 of the radially recessed tip pocket 29 may include the leading cooling air exhaust hole 30 in communication with an internal cooling channel 37 (see FIG. 6) of the turbine blade. The trailing portion 36 of the radially recessed tip pocket 29 may include a trailing cooling air exhaust hole 38 in communication with the internal cooling channel 37 of the turbine blade.

As seen in FIG. 4, to distribute stress, avoid stress concentration and reduce gas flow turbulence, the rib 27 can arcuately merge with the pressure side wall 33 with fillets 39 on both the leading and trailing sides of the rib 27. Likewise as best seen in FIG. 5, the rib 27 also can arcuately merge with the suction side wall 34 with fillets 40. The lateral side walls of the rib 27 can arcuately merge with a tip pocket floor 41 with fillets 42.

As shown in the example of FIG. 6, the leading portion 35 may have a length dimension “L₁” less than a length dimension “L₂” of the trailing portion 36. As indicated in FIG. 4, an airfoil cross-section of the radially recessed tip pocket 29 has a width dimension (perpendicular to the length dimension) defined between the pressure side wall 33 and the suction side wall 34, and the rib 27 may be disposed at a point of maximum width. Alternatively, multiple ribs 27 may be spaced apart along the length of the radially recessed tip pocket 29 between the leading edge 31 and trailing edge 32 to structurally support the pressure side wall 33 and suction side wall 34 at various locations. The height “h₂” of the rib 27 is less than the height “h₁” of the radially recessed tip pocket 29, thereby allowing cooling air flow from the leading cooling air exhaust hole 30 to flow downstream over the rib 27 and to continue cooling of the blade tip.

The durability of the airfoil blade tip (including the peripheral blade tip wall) is structurally reinforced by the rib without any change to the external airfoil geometry and with a negligible weight increase. The rib or multiple ribs can add stiffness to the airfoil blade tip and in particular to the peripheral blade tip wall 28 at locations needing reinforcement without significant reduction in cooling capability. Accordingly the thermo-mechanical fatigue life of the airfoil may be addressed by addition of a partial height rib 27 in accordance with the example described above and shown in the drawings.

The above description is meant to be exemplary only, and one skilled in the relevant arts will recognize that changes may be made to the embodiments described without departing from the present description. The present disclosure may be embodied in other specific forms without departing from the subject matter of the claims. The present disclosure is intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

What is claimed is:

1. A turbine blade comprising:
an airfoil having a root and a tip, the tip having a peripheral blade tip wall surrounding a radially recessed tip pocket, the peripheral blade tip wall having: a wall height; a leading edge; a trailing edge; a pressure side wall; and a suction side wall; and
a rib extending between the pressure side wall and the suction side wall defining a leading portion and a trailing portion of the radially recessed tip pocket, the rib having a rib height less than the wall height.

2. The turbine blade according to claim 1 wherein the leading portion of the radially recessed tip pocket includes a leading cooling air exhaust hole in communication with an internal cooling channel of the turbine blade.

3. The turbine blade according to claim 2 wherein the trailing portion of the radially recessed tip pocket includes a trailing cooling air exhaust hole in communication with the internal cooling channel of the turbine blade.

4. The turbine blade according to claim 1 wherein the rib arcuately merges with the pressure side wall with fillets.

5. The turbine blade according to claim 4 wherein the rib arcuately merges with the suction side wall with fillets.

6. The turbine blade according to claim 1 wherein the rib arcuately merges with a tip pocket floor with fillets.

7. The turbine blade according to claim 4 wherein the leading portion has a length dimension less than a length dimension of the trailing portion.

8. The turbine blade according to claim 7 wherein the radially recessed tip pocket has a width dimension defined between the pressure side wall and the suction side wall, and wherein the rib is disposed at a maximum width.

9. A gas turbine engine comprising:
a turbine including a plurality of turbine blades, at least one of the plurality of turbine blades having a peripheral blade tip wall surrounding a radially recessed tip pocket, the peripheral blade tip wall having: a wall height; a leading edge; a trailing edge; a pressure side wall; and a suction side wall; and
a rib extending between the pressure side wall and the suction side wall defining a leading portion and a trailing portion of the radially recessed tip pocket, the rib having a rib height less than the wall height.

10. The gas turbine engine according to claim 9 wherein the leading portion of the radially recessed tip pocket includes a leading cooling air exhaust hole in communication with an internal cooling channel of the turbine blade.

11. The gas turbine engine according to claim 10 wherein the trailing portion of the radially recessed tip pocket includes a trailing cooling air exhaust hole in communication with the internal cooling channel of the turbine blade.

12. The gas turbine engine according to claim 9 wherein the rib arcuately merges with the pressure side wall with fillets.

13. The gas turbine engine according to claim 12 wherein the rib arcuately merges with the suction side wall with fillets.

14. The gas turbine engine according to claim 9 wherein the rib arcuately merges with a tip pocket floor with fillets.

15. The gas turbine engine according to claim 12 wherein the leading portion has a length dimension less than a length dimension of the trailing portion.

16. The gas turbine engine according to claim 15 wherein the radially recessed tip pocket has a width dimension defined between the pressure side wall and the suction side wall, and wherein the rib is disposed at a maximum width.
